(19) United States
(12) Patent Application Publication
(10) Pub. No.: US 2007/0266319 A1
(43) Pub. Date: Nov. 15, 2007

(54) Electronic apparatus control method, computer readable medium, and computer data signal

(75) Inventor: Takenori Matsuo, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/639,249

(22) Filed: Dec. 15, 2006

(30) Foreign Application Priority Data
May 9, 2006 (JP) 2006-129791

(51) Int. Cl. G06F 3/00; G06F 3/048

(52) U.S. Cl. 715/700; 715/853

(57) ABSTRACT

A method of controlling an electronic apparatus includes: displaying, on a desktop screen, a function setting region in which an instruction to execute a plurality of processes sequentially is set; specifying graphical relevance between the function setting region and at least one file, on the desktop screen; and executing the plurality of processes set in the function setting region on the file relevant to the function setting region.

### BACKGROUND

1. Technical Field

The present invention relates to a personal computer control technique, etc. using a GUI (graphical user interface). Particularly, it relates to a technique in which a region provided with a function for issuing an instruction to execute a predetermined process is set on a screen so that the set predetermined process is automatically executed when a file is dragged and dropped into the region.

2. Related Art

In an operation using a GUI in a personal computer or the like, for example, an operation of dragging and dropping a file into an icon indicating a function on a tool bar or an operation of selecting a file in advance, displaying a menu of processes and selecting a process from the menu of processes is performed as an operation for performing a predetermined process on the file.

### SUMMARY

According to an aspect of the present invention, a method of controlling an electronic apparatus includes: displaying, on a desktop screen, a function setting region in which an instruction to execute a plurality of processes sequentially is set; specifying graphical relevance between the function setting region and at least one file, on the desktop screen; and executing the plurality of processes set in the function setting region on the file relevant to the function setting region.

### BRIEF DESCRIPTION OF THE DRAWINGS

Exemplary embodiment of the present invention will be described in detail based on the following figures, wherein:

FIG. 1 is a block diagram showing a configuration example for implementing an action of an electronic apparatus according to the invention;

FIG. 2 is a screen display view showing an example of a desktop screen display according to the invention;

FIGS. 3A and 3B are screen display views showing examples of desktop screen displays according to the invention;

FIG. 4 is a conceptual view showing an example of a flow of processes according to the invention;

FIGS. 5A and 5B are screen display views showing examples of desktop screen displays according to the invention;

FIG. 6 is a conceptual view showing an example of a flow of processes according to the invention;

FIGS. 7A and 7B are screen display views showing examples of desktop screen displays according to the invention;

FIGS. 8A and 8B are screen display views showing examples of desktop screen displays; and

FIG. 9 is a conceptual view for explaining the contents of processes set in a function setting region.

### DETAILED DESCRIPTION

### First Embodiment

### Configuration of Embodiment

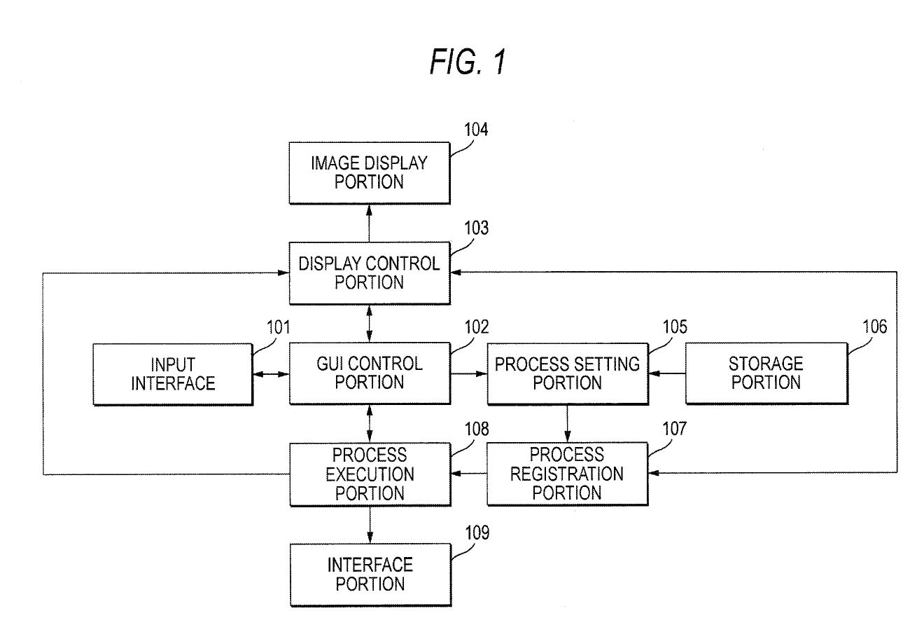

FIG. 1 is a block diagram showing a system for implementing the invention. For example, the configuration shown in FIG. 1 is implemented by a personal computer and software installed in the personal computer. In FIG. 1, an input interface 101 is an input interface of a pointing device typified by a mouse. The input interface 101 receives a character entry signal from a keyboard not shown, converts the character entry signal into a predetermined standard signal and outputs the standard signal to a GUI control portion 102. The GUI control portion 102 outputs a control signal to a display control portion 103 based on the signal from the input interface 101 in order to perform display based on the operation result of the pointing device. The GUI control portion 102 also outputs an instruction signal to a process execution portion 108 in order to execute a process designated by the operation of the pointing device.

The display control portion 103 generates an image control signal to be outputted to an image display portion 104, on the basis of the signal from the GUI control portion 102. The display control portion 103 performs display control so that the display position of a function setting region registered in a process registration portion 107 is unchanged on the screen. The image display portion 104 is a display in a personal computer, etc. A process setting portion 105 performs setting of the function setting region to be set on the screen of the image display portion 104. A storage portion 106 stores application software. The application software includes mail software, document preparation tool software, translation software, document management software, spreadsheet software, document analysis software, image processing software, audio analysis software, driver software of an external apparatus such as a printer, and other software installed in the computer and capable of executing various processes. For example, a hard disk device may be used as the storage portion 106.

The process registration process 107 manages contents of the setting of the function setting region set in the process setting portion 105 and data about the position of the function setting region on the display screen. The process execution portion 108 executes a process registered in the process registration portion 107. A result of the executed process is sent to the display control portion 103 and displayed on the image display portion 104. An interface portion 109 outputs the result of the process executed in the process execution portion 108 to a not-shown external apparatus (such as a printer or a communication modem).

### (Operation for Setting of Function Setting Region)

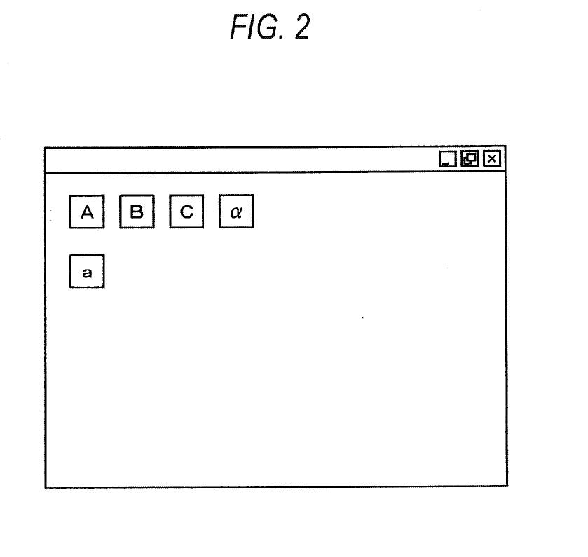

FIG. 2 shows an example of a desktop screen displayed on the screen of the image display portion 104 in FIG. 1. In FIG. 2, icons A to C, an icon α and an icon a are displayed. The icon A is an OCR software icon for obtaining text data from image data. The icon B is a translation software icon for translating an English document into Japanese. The icon C is an encryption software icon. The icon a is an icon for software capable of setting a function setting region. The icon a is an icon for indicating an image data file of an English document read by a scanner.

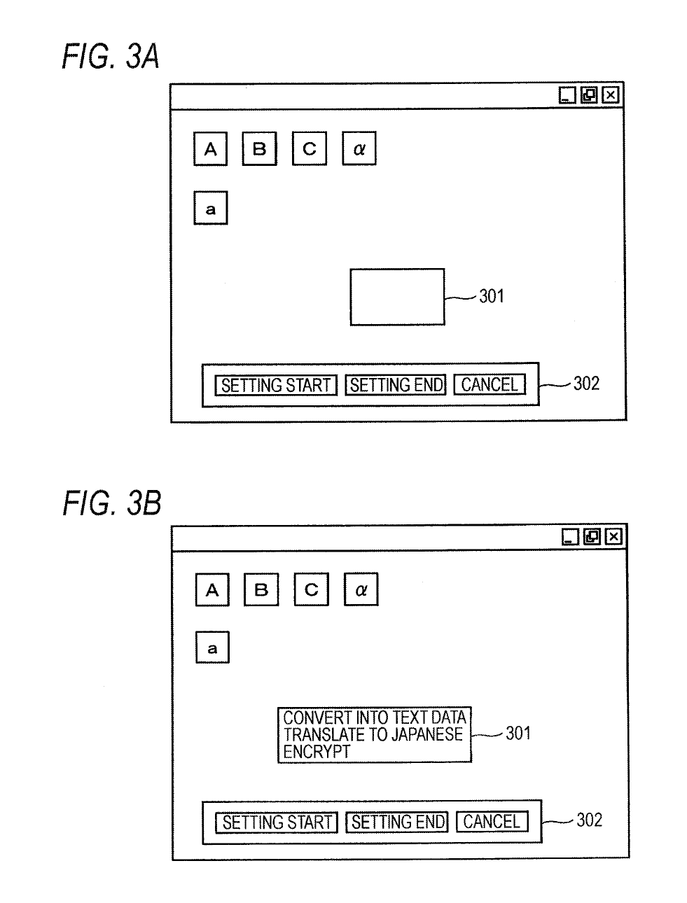

FIG. 3A or 3B is an example of a desktop screen displayed on the screen of the image display portion 104 in FIG. 1. When the icon α is clicked on the screen shown in FIG. 2, a function setting region 301 is displayed on the screen as shown in FIG. 3A. Although the shape and size of the function setting region 301 are optional, FIG. 3A or 3B shows that the function setting region 301 shaped like a rectangle is displayed in the center of the screen. A window 302 is also opened. Buttons “setting start”, “setting end” and “cancel” are displayed in the window 302.

In this example, a function of executing a series of processes for converting image data into text data, applying English-Japanese mechanical translation to the text data to translate English into Japanese and encrypting the Japanese text data is set in the function setting region 301. In this case, a user first renders display of proper titles to the function setting region. Here, the user inputs display as shown in FIG. 3B in which processes set in the function setting region can be grasped plainly. This display is inputted by a right click operation of a mouse and an operation of a keyboard in the same manner as in the general case where the name of a file is changed on the desktop screen.

Next, an operation for setting processes in the function setting region 301 is performed. In this example, the button “setting start” in the window 302 is first clicked by a left click operation of the mouse. As a result, the function setting region 301 is enabled to be set. In this condition, drag and drop of the icon A into the function setting region 301, drag and drop of the icon B into the function setting region 301 and drag and drop of the icon C into the function setting region 301 are performed successively. Then, the button “setting end” is clicked by a left click operation of the mouse, so that the setting process is terminated. When the button “setting end” is clicked, the window 302 is closed. The function setting region 301 is moved to an arbitrary position on the screen by a drag operation of the mouse. In this manner, the operation for setting of the function setting region 301 is completed. Incidentally, when a drag operation is performed while a pointer image is placed at an edge of the function setting region 301, the size of the function setting region 301 can be changed freely.

### (Action During Setting Operation)

Description will be given to the action of the configuration shown in FIG. 1 during the operation for setting the function setting region 301. First, description will be given to the action when drag and drop of the icon A into the function setting region 301 is performed on the screen shown in FIG. 3B. In this case, the GUI control portion 102 recognizes the fact that the icon A is dragged and dropped into the function setting region 301. The GUI control portion 102 outputs a result of the recognition to the process setting portion 105. The process setting portion 105 reads a program A (an OCR software program in this case) of the icon A stored in the storage portion 106 on the basis of the output and temporarily holds the program A of the icon A.

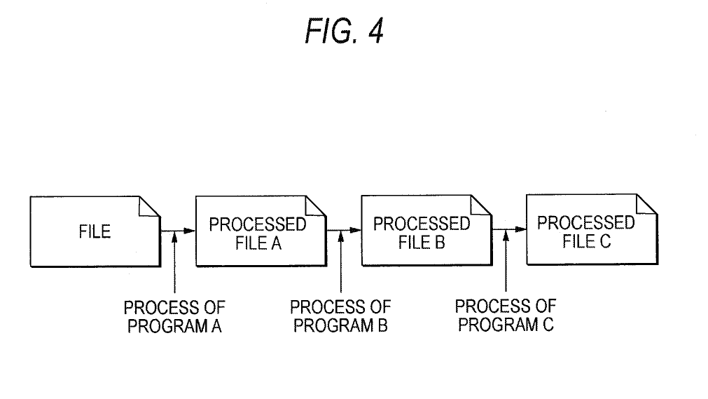

When drag and drop of the icon B into the function setting region 301 is then performed, a program B (an English-Japanese translation software program in this case) of the icon B is read from the storage portion 106 into the process setting portion 105 in the same manner as the case of the icon A. FIG. 4 is a conceptual view for explaining contents of setting in the process setting portion 105. When the GUI is operated on the screen shown in FIG. 3B so that the icon A is dragged and dropped into the function setting region 301 and then the icon B is dragged and dropped into the function setting region 301, a procedure of executing a process of the program A on a predetermined file to obtain a processed file A and then executing a process of the program B on the processed file A to obtain a processed file B is set in the process setting portion 105 as shown in FIG. 4.

When the icon C is then dragged and dropped into the function setting region 301, a program C (an encryption software program in this case) of the icon C is read from the storage portion 106 into the process setting portion 105 in the same manner as in the case of the icon A or B. On this occasion, a procedure of executing a process of the program C on the processed file B to obtain a processed file C is set in the process setting portion 105 as shown in FIG. 4.

When the button “setting end” shown in FIG. 3B is then clicked, a program for determining the procedure of processes shown in FIG. 4 and the programs A to C are transferred from the process setting portion 105 into the process registration portion 107.

### (Process Using Function Setting Region)

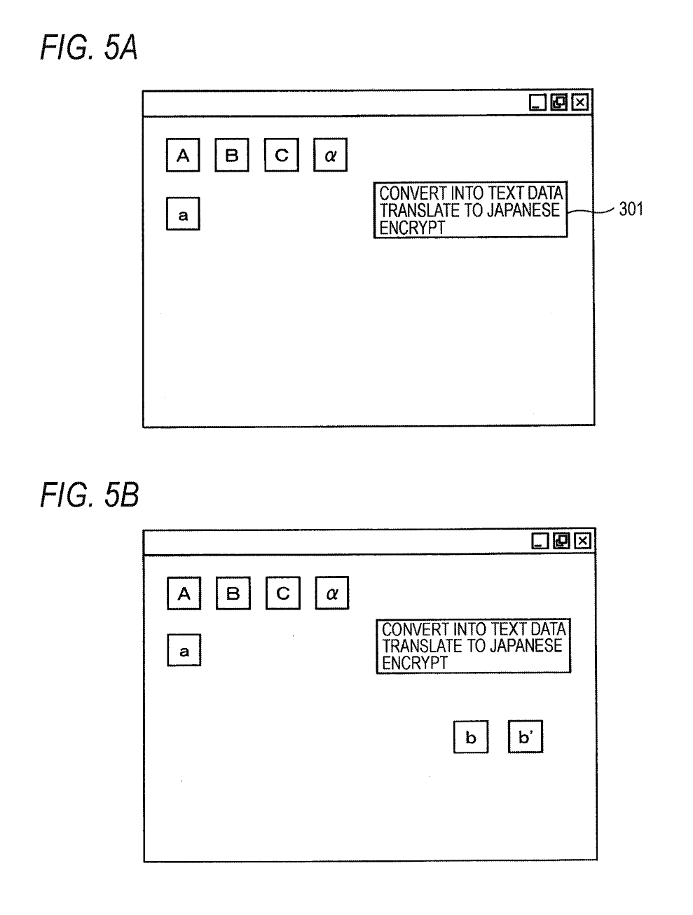

FIG. 5A or 5B is an example of a desktop screen displayed on the screen of the image display portion 104 in the condition that the function setting region 301 is ready for use after the setting process of the function setting region 301 shown in FIG. 3B is completed. Here, description will be given to an example in which a series of processes shown in FIG. 4 are performed by batch processing on English image data of a file a. In this case, the user operates the mouse on the screen shown in FIG. 5A so that the file is dragged and dropped into the function setting region 301. As a result, the process of the program A is executed on the file a, the process of the program B is executed on a thus obtained file, and the process of the program C is executed on a thus obtained file.

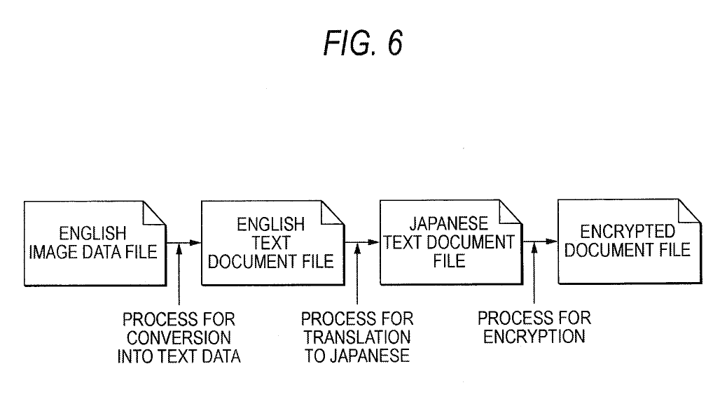

FIG. 6 is a conceptual view for explaining the contents of this process. When the aforementioned operation is performed, a process of converting image data into text data by OCR software is first executed on an English image data file as the file a so that an English text document file based on the text data conversion is obtained as shown in FIG. 6. Then, a Japanese translation process is executed on the English text document file so that a Japanese text document file is obtained. Then, an encryption process is executed on the Japanese text document file so that an encrypted Japanese document file is obtained. As shown in FIG. 5B, the encrypted Japanese document file is displayed as a file b on the screen. On this occasion, it is preferable that the icon display of the file b is designed to have such good looks that it is easy to find the fact that the file b is a file obtained by use of the function setting region 301. For example, it is preferable that the icon b is displayed with an indication of “processed” while the display is blinked on and off to make it easy to recognize the display.

In addition, in this process, the English text document is also encrypted in the encryption process. An icon b′ in FIG. 5B indicates the encrypted English document file. Since the text document before translation is also encrypted, the work for checking the translation afterwards can be performed efficiently. On this occasion, a folder for storing both icons b and b′ may be displayed. In this manner, respective results of the processes using the function setting region 301 can be managed collectively.

Since the process to be executed on the file a can be executed by only drag and drop of the file a into the function setting region 301, high convenience can be gained in the case where plural files are to be processed or in the case where plural processes are executed consecutively. Although description has been made here on the case where one function setting region 301 is provided, plural function setting regions may be provided alternatively.

### (Action in Process by Use of Function Setting Region)

An example of an action in the process shown in FIG. 6 will be described. When the file a is dragged and dropped into the function setting region 301 on the screen shown in FIG. 5A, the GUI control portion 102 in FIG. 1 recognizes this fact and sends a result of the recognition to the process execution portion 108. Upon reception of the result, the process execution portion 108 reads the functions of the function setting region 301 (see FIGS. 5A and 5B) registered in the function registration portion 107. That is, the function execution portion 108 reads a group of programs for executing a series of processes registered in the process registration process 107 and shown in FIG. 4 and a program for controlling a procedure of execution of the group of programs. Then, the process execution portion 108 executes the series of processes shown in FIG. 4 on the dragged and dropped file a. That is, the process execution portion 108 executes the processes shown in FIG. 6 on the file a as English image data. Although not shown in FIG. 6, an encryption process is also executed on the English text document file at proper timing by the process execution portion 108.

When the encrypted document files are obtained by encryption of both data of the Japanese text document and the English text document, icon display information of the encrypted document files is transmitted from the process execution portion 108 to the display control portion 103 so that the icon b (the icon of the encrypted Japanese text document file) and the icon b′ (the icon of the encrypted English text document file) are displayed on the image display portion 104 as shown in FIG. 5B.

### (Unchanged Display of Function Setting Region)

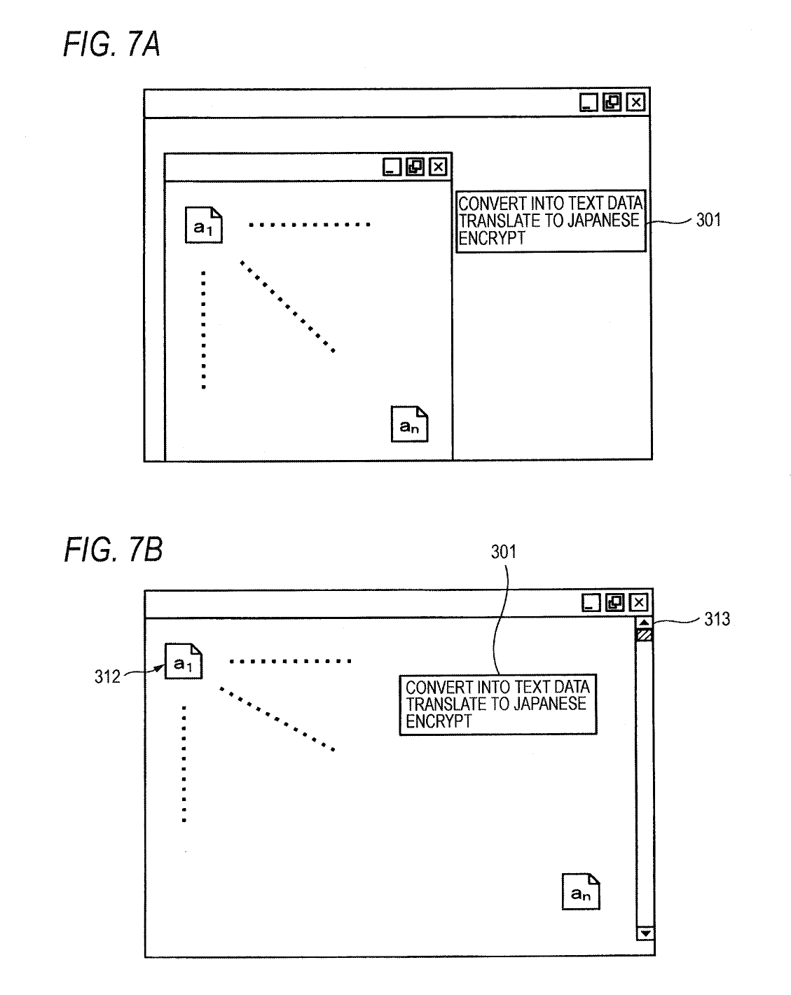

For example, assume that the icon a shown in FIGS. 5A and 5B indicates a folder containing plural image data files. FIG. 7A or 7B is an example of a desktop screen displayed on the screen of the image display portion 104. In this case, the icon of the folder a shown in FIG. 5A is first left clicked. As a result, a window 311 is opened while files a₁ . . . aₙ obtained by unfolding the folder a are displayed as shown in FIG. 7A. On this occasion, the window 311 is displayed in a position to avoid the function setting region 301. In this manner, the function setting region 301 can be always displayed in a fixed position. The function setting region 301 can be always kept easy to use.

When the function setting region 301 is dragged and dropped into the window 311, the function setting region 301 is displayed in the inside of the window 311. When the window 311 is further displayed on the whole screen, a screen shown in FIG. 7B is displayed. On this occasion, display of a file group 312 is rearranged to avoid the position where the function setting region is dragged and dropped. When a folder having plural files stored therein is contained in the file group 312, the folder can be further unfolded and displayed and the function setting region 301 can be dragged and dropped into the unfolded folder and displayed therein.

When the number of file groups 312 is large, all the file groups 312 cannot be displayed on the screen. In this case, a screen scroll operation using a scroll bar 313 is performed to display files which are out of screen in FIG. 7B. During the screen scroll operation, the file groups 312 move simultaneously vertically in accordance with the scroll operation but the function setting region 301 is continuously displayed in the same position without movement. In the case where icon display of files contained in the file groups 312 overlaps with display of the function setting region 301 during the scroll operation, the display state is controlled to give the highest priority to display of the function setting region 301 so that the icons of the files overlapping with the function setting region 301 are hidden behind the function setting region 301.

Since the function setting region 301 is displayed continuously regardless of scroll display, the function setting region 301 can be used immediately when a target file is found through scroll display. If the function setting region 301 were also moved on the display screen shown in FIG. 7B during the screen scroll process, the function setting region 301 might be out of screen due to scrolling so that the file could not be dragged and dropped into the function setting region 301 easily even after finding of the file to be searched.

### (Action during Unchanged Display of Function Setting Region)

Description will be made on an example of an action which is controlled so that a display region of the window 311 shown in FIG. 7A is prevented from overlapping with the function setting region 301 when the window 311 is displayed. In this case, in the configuration shown in FIG. 1, the GUI control portion 102 adjusts the size of the window 311 on the screen in a range where the display region of the window 311 and the display region of the function setting region 301 do not overlap with each other.

Description will be given to an example of an action when the function setting region 301 is dragged and dropped into the window 311 in the condition of the screen display shown in FIG. 7A. In this case, in the configuration shown in FIG. 1, a signal indicating drag and drop of the function setting region 301 into the window 311 is outputted from the input interface 101 to the GUI control portion 102. On the basis of the signal, the GUI control portion 102 outputs a signal for changing the display position of the function setting region 301, to the display control portion 103. The display control portion 103 changes the display position of the function setting region 301 on the basis of the signal and displays the function setting region 301 on the image display portion 104. On this occasion, the display control portion 103 positions the display position of the function setting region 301 in the window 311 so that the display position of the function setting region 301 approximately matches with the position on the screen shown in FIG. 7A (near the upper right of the screen in this case). When a file contained in a file group a₁ . . . aₙ is present in a position overlapping with the display position of the function setting region 301, the display control portion 103 executes a rearrangement process to display the file in a position not overlapping with the position of the function setting region 301. A signal indicating the fact that the function setting region 301 is associated with the inside of the window 311 is outputted from the display control portion 103 to the process registration portion 107. Thus, the process registration portion 107 recognizes the signal.

When an operation for displaying the window 311 shown in FIG. 7A as the whole screen is then performed, the process for displaying the window 311 as the whole screen is executed in the display control portion 103 so that the screen shown in FIG. 7B is displayed in the image display portion 104. When, in this condition, a proper file is selected from the file group 312 and dragged and dropped into the function setting region 301, the process shown in FIG. 4 is executed on the file.

Next, description will be made on an example of an action when scroll display for displaying the file group 312 which cannot be displayed is performed in the screen display shown in FIG. 7B. In this case, a signal indicating the fact that an operation for designating scroll display is performed is outputted from the input interface 101 to the GUI control portion 102 in the configuration shown in FIG. 1. The GUI control portion 102 recognizes the signal and outputs a control signal for performing scroll display to the display control portion 103. The display control portion 103 recognizes this control signal and refers to information about the function setting region 301 registered in the process registration portion 107. Since data indicating the fact that the function setting region 301 is associated with the inside of the screen shown in FIG. 7B are stored in the process registration portion 107, the display control portion 103 in the aforementioned action recognizes the fact that the function setting portion 301 is displayed in the predetermined position on the screen shown in FIG. 7B. Since the display position of the function setting region 301 is set so that it is not moved on the screen even in the case where any other display is moved, the display control portion 103 performs image display control so that the function setting region 301 is not moved but only the file group 312 is moved in the scroll display on the screen shown in FIG. 7B. During the scrolling, display control is performed so that icon display of the file group 312 overlapping with the function setting region 301 is hidden behind the function setting region 301. In this manner, when the screen shown in FIG. 7B is scrolled and displayed, control is performed so that the file group 312 is scrolled and displayed while display of the function setting region 301 is not moved but displayed in the same position continuously.

### Second Embodiment

For example, plural files selected from the file group 312 on the screen display shown in FIG. 7B may be dragged and dropped into the function setting region 301 simultaneously so that the files are subjected to the process shown in FIG. 6 successively. In this case, the process shown in FIG. 6 is executed on each of the selected files. A folder having plural files stored therein may be dragged and dropped into the function setting region 301 so that a predetermined process is executed on each of the files stored in the folder.

### Third Embodiment

Description will be made on an example in the case where a printing process is performed in place of encryption in the process shown in FIG. 6. In this case, an image data file a of an English document is dragged and dropped into the function setting region 301 on the display screen shown in FIG. 5A. The English image data file a dragged and dropped into the function setting region 301 is first converted into text data by OCR software and then translated to Japanese text data by Japanese translation software automatically. The translated Japanese text data are printed out by a printer not shown. In this case, when the file of English image data read by an optical scanner is simply dragged and dropped into the function setting region, conversion of the image data into text data, translation of the English document of the text data into Japanese and printing of the translated Japanese document are performed automatically.

In this case, a printer not shown is connected to the interface portion 109 in the configuration shown in FIG. 1. Printing data of the translated Japanese document data are sent from the interface portion 109 to the not-shown printer and printed by the printer.

### Fourth Embodiment

The first to third embodiments have been described on the case where drag and drop of a to-be-processed file into a function setting region is used as a method of associating the file with the function setting region. As an example of the method for obtaining the same function, a to-be-processed file can be selected by a click operation of a mouse, and an instruction to send the selected file to the function setting region can be issued by another click operation of the mouse. This can be implemented by the same mechanism as the technique using a click operation of a mouse to perform a transfer operation between folders of files.

### Fifth Embodiment

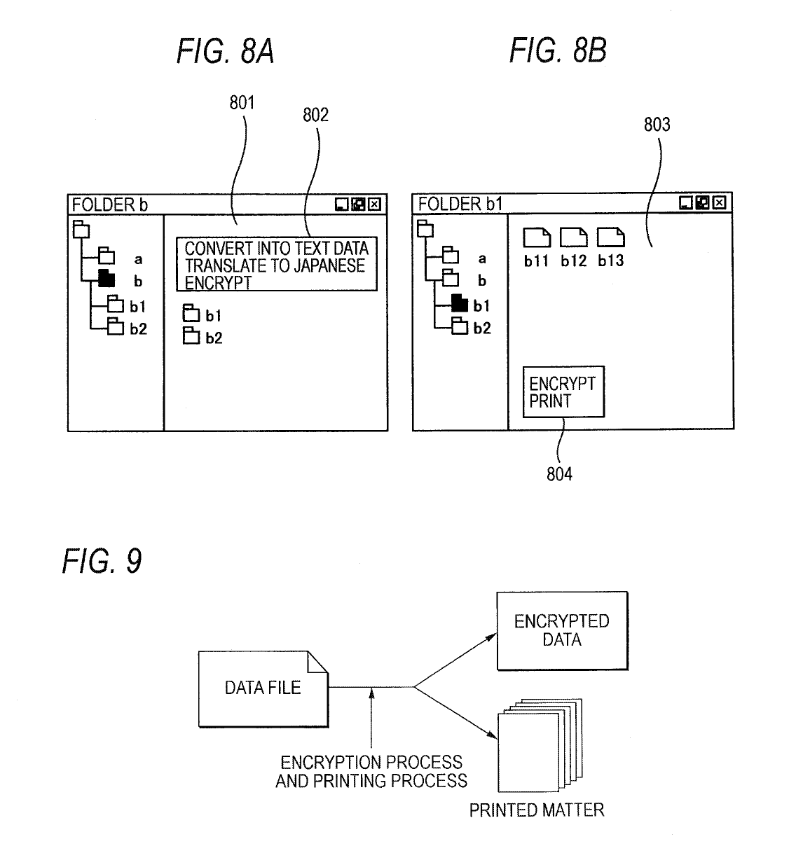

Function setting regions and functions thereof may be set in accordance with different folders (i.e. different windows). An example of this embodiment will be described below. FIG. 8A or 8B is a screen display view showing an example of display on a desktop screen.

FIG. 8A shows a state in which a folder b is selected and data stored in the inside of the folder b are displayed on a screen 801. When the folder b is selected in this example, lower-level folders b1 and b2 stored in the folder b are displayed on the screen 801. A function setting region 802 is set in the folder b. Setting of the function setting region 802 is the same as that described in the first embodiment. A series of processes shown in FIG. 6 are set in the function setting region 802. When the folder b1 and/or the folder b2 are dragged and dropped into the function setting region 802 on the desktop screen shown in FIG. 8A, the processes shown in FIG. 6 (see the first embodiment for further details) are executed on the folder b1 and/or the folder b2.

FIG. 8B shows a state in which the folder b1 in FIG. 8A is selected and data stored in the inside of the folder b1 are displayed on a screen 803. When the folder b1 is selected in this example, files b11, b12 and b13 stored in the folder b1 are displayed on the screen 803. A function setting region 804 is set in the folder b1. A process of encrypting data and a process of printing the data (data before encryption) are set in the function setting region 804. FIG. 9 is a conceptual view for explaining the contents of the processes set in the function setting region 804. In accordance with the setting, when, for example, a document file is dragged and dropped into the function setting region 804, the contents of the document file are printed, and at the same time, data obtained by encrypting the document file are created. Because such a series of processes can be performed by one drag and drop, it is convenient for the case where an operation of storing an edited document as a paper medium and an electronic medium needs to be performed. The method for setting the function setting region 804 is the same as that described in the first embodiment.

When the function setting regions are set in accordance with the folders as shown in FIGS. 8A and 8B, coordinate information of a function setting region corresponding to each folder and information of relevant functions of the function setting region are registered in the process registration portion 107 shown in FIG. 1. When a predetermined folder is selected, the process execution portion 108 recognizes functions of a function setting region set for the folder on the basis of the information.

Because a function setting region having functions varying in accordance with each folder is set as described in this embodiment, processes specific to each folder can be set in accordance with the folder. Thus, user's convenience can be increased when each folder is created and managed in accordance with the contents of processes. Although description in conjunction with FIGS. 8A and 8B has been made on the case where the function setting regions are set to have different functions between the folder b and the lower-level folder b1, function setting regions may be set to have different functions between the folder a and the folder b (or the folder b1 and the folder b2) which are the same in level.

### Other Embodiments

While the function setting region 301 is not displayed on the screen display shown in FIG. 5A in the ordinary case, the function setting region 301 may be displayed when a function key of a not-shown keyboard is pushed. Function setting regions having different process contents may be registered in plural function keys in advance, so that a function setting region can be called on the screen when a corresponding function key for execution of a predetermined process is pushed. In addition, the function setting region 301 may be separated into upper and lower parts so that the upper part is used as a region for execution of a first processing procedure and the lower part is set as a region for execution of a second processing procedure.

Each process using the function setting region is not limited to an operation of a personal computer but applicable to an operation of a work station, an operation of a measuring instrument or an operation of a mobile information processing terminal or a mobile phone. In the case of a measuring instrument, consecutive processes, i.e. a process of graphing measured data and a process of analyzing the graphed data may be required. In this case, when these processes and the sequence thereof are set in the function setting region in advance, data processing can be performed collectively by one operation using the GUI without necessity of any troublesome operation. Since the area of a display screen in a mobile information processing terminal or a mobile phone is small, an operation of the GUI such as an operation of moving an icon several times is troublesome. With respect to the function setting region according to the invention, a region with any size can be however set in any position. Because plural processes in the function setting region can be executed by one operation, the function setting region is suitable for an operation of an electronic apparatus with a small display screen.

The invention can be applied to an electronic apparatus which is typified by a personal computer and which can be operated by use of GUI.

A personal computer, a work station, a main frame terminal, an information processing terminal, a control apparatus, a machine tool, a game machine, a measuring instrument, a communication apparatus, an audio apparatus, a visual apparatus, an audio and visual apparatus, a multifunctional apparatus having a combination of functions of these apparatuses (such as an information processing terminal having a communication function), and any other electronic apparatus which can be operated using a GUI can be used as the electronic apparatus to which the invention is applied. Since the invention is placed on the assumption that the apparatus is operated using a GUI (graphical user interface), a display is required for operating the apparatus. The display may be unified with the apparatus or may be added externally to the apparatus. The desktop screen means a screen on which an operation using the GUI can be performed. As long as an operation using the GUI such as drag and drop of a file or folder can be performed even on a screen in which some application software has been opened, the screen can be grasped as the desktop screen in the invention.

Processes using the function setting region may be performed on one file or may be performed by batch processing on a plurality of files. Alternatively, these processes may be performed on a folder having one file or a plurality of files stored therein. Printing, a process of converting image data into a text document (OCR process), an electronic labeling process, an encryption process, a decryption process, a translation process, a data compression process, a data expansion process, a keyword searching process, a data standard changing process (such as change of a standard of the image data), a transmission process (transmission of data to another terminal or transmission of an electronic mail), an automatic backup process, a graphing process, and another documentation or image processing process can be used as the processes set in the function setting region.

Relevance between the function setting region and a file can be performed visually using the GUI. Specifically, the relevance can be performed by an operation of dragging and dropping a predetermined file to the function setting region, or an operation of designating a predetermined file and a function setting region.

The foregoing description of the embodiments of the present invention has been provided for the purpose of illustration and description. It is not intended to be exhaustive or to limit the invention to the precise forms disclosed. Obviously, many modification and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claim and their equivalents.

What is claimed is:

1. A method of controlling an electronic apparatus comprising:
displaying, on a desktop screen, a function setting region in which an instruction to execute a plurality of processes sequentially is set;
specifying graphical relevance between the function setting region and at least one file, on the desktop screen; and
executing the plurality of processes set in the function setting region on the file relevant to the function setting region.

2. The electronic apparatus control method according to claim 1, wherein
setting of a sequence to execute the plurality of processes comprises:
specifying relevance between one of displays showing respective processes on the desktop screen and the function setting region;
acquiring a sequence for which the relevance is specified; and
setting the plurality of processes to be executed in the acquired sequence.

3. A method of controlling an electronic apparatus, comprising:
displaying, in an arbitrary position on a desktop screen, a function setting region in which an instruction to execute a predetermined process is set;
specifying graphical relevance between the function setting region and at least one file, on the desktop screen;
executing the process set in the function setting region on the file relevant to the function setting region; and
continuously displaying the function setting region in an unchanged display position when display other than display of the function setting region is changed on the desktop screen.

4. A computer readable medium storing a program causing a computer to execute a process for controlling an electronic apparatus, the process comprising:
displaying, on a desktop screen, a function setting region in which an instruction to execute a plurality of processes sequentially is set;
specifying graphical relevance between the function setting region and at least one file, on the desktop screen; and
executing the plurality of processes set in the function setting region on the file relevant to the function setting region in a set sequence.

5. A computer readable medium storing a program causing a computer to execute a process for controlling an electronic apparatus, the process comprising:
displaying, in an arbitrary position on a desktop screen, a function setting region in which an instruction to execute a predetermined process is set;
specifying graphical relevance between the function setting region and at least one file, on the desktop screen;
executing the process set in the function setting region on the file relevant to the function setting region; and
continuously displaying the function setting region in an unchanged display position when display other than display of the function setting region is changed on the desktop screen.

6. A computer data signal embodied in a carrier wave for enabling a computer to perform a process for controlling an electronic apparatus, the process comprising:
displaying, on a desktop screen, a function setting region in which an instruction to execute a plurality of processes sequentially is set;
specifying graphical relevance between the function setting region and at least one file, on the desktop screen; and
executing the plurality of processes set in the function setting region on the file relevant to the function setting region.

7. A computer data signal embodied in a carrier wave for enabling a computer to perform a process for controlling an electronic apparatus, the process comprising:
displaying, in an arbitrary position on a desktop screen, a function setting region in which an instruction to execute a predetermined process is set;
specifying graphical relevance between the function setting region and at least one file, on the desktop screen;
executing the process set in the function setting region on the file relevant to the function setting region; and
continuously displaying the function setting region in an unchanged display position when display other than display of the function setting region is changed on the desktop screen.
